(19) United States
(12) Patent Application Publication
(10) Pub. No.: US 2004/0086317 A1
(43) Pub. Date: May 6, 2004

(54) Holder for releasably holding conventional cosmetic tools

(76) Inventor: Tania W. Hanna, Vienna, VA (US)

Correspondence Address: Lance L. Vietzke, Snell & Wilmer, 400 East Van Vuren, Phoenix, AZ, 85004-2202, US

(21) Appl. No.: 10/697,812

(22) Filed: Oct. 30, 2003

Related U.S. Application Data
(63) Continuation-in-part of application No. 09/816,416, filed on Mar. 26, 2001, now abandoned.

(51) Int. Cl. B05C 1/00; B43K 27/02

(52) U.S. Cl. 401/19; 401/18; 401/17

(57) ABSTRACT

A holder includes a main body having two ends that hold cosmetic tools substantially parallel to a central axis of the tool, and it can also include caps for placement over the cosmetic tools. The caps can have a reflective outer surface for use as a mirror. The ends can be configured to hold cosmetic tools having variable dimensions by using a chuck mechanism or a compressible material in the ends of the holder. With cosmetic tools held in place and the caps installed, the holder provides for a way to carry and use a variety of cosmetic tools such as lipstick, lip liner, eye liner, eye shadow, or other tools.

### REFERENCE TO RELATED APPLICATION

The present application is a continuation-in-part of U.S. patent application Ser. No. 09/816,416, entitled “Cosmetic Tool for Releasably Holding Cosmetic Products,” and filed Mar. 26, 2001, which is incorporated herein by reference.

### FIELD OF THE INVENTION

The present invention relates to a holder for releasably holding conventional cosmetic tools such that at least one of the cosmetic tools can be replaced in the holder.

### BACKGROUND OF THE INVENTION

Individuals often use cosmetic tools in order to enhance their appearance. These cosmetic tools include, for example, lipstick and lip liner. The application of lipstick generally involves first applying lip liner to outline the lips and then applying lipstick over the lips. When a person applies lipstick to oneself, the application also requires a mirror to ensure proper application of the lip liner and lipstick.

The cosmetic tools are usually carried in a container, such as purse, to have them available at various times throughout the day to apply or re-apply the products. Therefore, use of lipstick requires a person to carry at least three articles, lip liner, lipstick, and a mirror. These three separate articles can be cumbersome to carry in a purse and, when contained in a large purse or bag, can be difficult to locate if mixed in with many other items. Carrying additional cosmetic tools such as eye liner and eye shadow only compounds the problem.

Accordingly, a need exists for a more convenient way to carry and hold multiple cosmetic tools.

### SUMMARY OF THE INVENTION

A holder consistent with the present invention includes a main body having first and second ends. The first end has a first holder for holding a first cosmetic tool, and the second end has a second holder for holding a second cosmetic tool. At least one of the first or second holders, and possibly both, provides for releasably holding one of the cosmetic tools so that it can be replaced. And at least one of the first cosmetic tool or the second cosmetic tool is a conventional cosmetic tool designed for use as a separate unit not requiring the first holder or the second holder, respectively.

A method of applying cosmetic products consistent with the present invention includes the steps of applying a first cosmetic product from a first cosmetic tool releasably held on a first end of a holder, and applying a second cosmetic product from a second cosmetic tool releasably held on a second end of the holder. In this method, at least one of the applying steps includes applying the first or the second cosmetic product using the holder and at least one of the first cosmetic tool or the second cosmetic tool is a conventional cosmetic tool designed for use as a separate unit not requiring the first holder or the second holder, respectively.

### BRIEF DESCRIPTION OF THE DRAWINGS

The accompanying drawings are incorporated in and constitute a part of this specification and, together with the description, explain the advantages and principles of the invention. In the drawings,

FIG. 1 is a side view of a prior art conventional lipstick cosmetic tool;

FIG. 2 is a side view of a prior art conventional lip liner cosmetic tool;

FIG. 3 is a side view of a holder to illustrate how the conventional cosmetic tools of FIGS. 1 and 2 are installed within the holder for use in one embodiment;

FIG. 4 is a side view of a holder to illustrate how the conventional cosmetic tools of FIGS. 1 and 2 can be released from the holder in one embodiment;

FIG. 5 is a perspective view of an embodiment of a holder for releasably holding cosmetic tools;

FIG. 6 is a side view of the holder shown in FIGS. 3-5;

FIG. 7 is a first end view of the holder shown in FIGS. 3-5;

FIG. 8 is a second end view of the holder shown in FIGS. 3-5;

FIG. 9 is a perspective view of an embodiment of a holder for releasably holding cosmetic tools and optionally including caps;

FIG. 10 is a side view of the holder shown in FIG. 9;

FIG. 11 is a side view of a cap shown with the holder in FIG. 9;

FIG. 12 is a first end view of the holder shown in FIG. 9;

FIG. 13 is a second end view of the holder shown in FIG. 9;

FIG. 14 is a side sectional view of a portion of the holder shown in FIG. 9 illustrating an optional holder for releasably containing a cosmetic tool;

FIG. 15 is a side sectional view of the holder shown in FIG. 9 illustrating a friction fit for the caps;

FIG. 16 is a side sectional view of the holder shown in FIG. 9 illustrating a snap fit for the caps;

FIG. 17 is a side sectional view of the holder shown in FIG. 9 illustrating a threaded fit for the caps;

FIG. 18 is a perspective view of the holder shown in FIG. 9 with the caps installed;

FIG. 19 is a perspective view of an embodiment of a holder for releasably holding cosmetic tools and including a chuck mechanism for holding variable size cosmetic tools;

FIG. 20 is an end view of the holder shown in FIG. 19;

FIG. 21 is a perspective view of an embodiment of a holder for releasably holding cosmetic tools and including a compressible material for holding variable size cosmetic tools;

FIG. 22 is a side sectional view of the holder shown in FIG. 21; and

FIG. 23 is a side sectional view of the holder shown in FIG. 21 with cosmetic tools releasably installed.

### DETAILED DESCRIPTION

### Conventional Cosmetic Tools

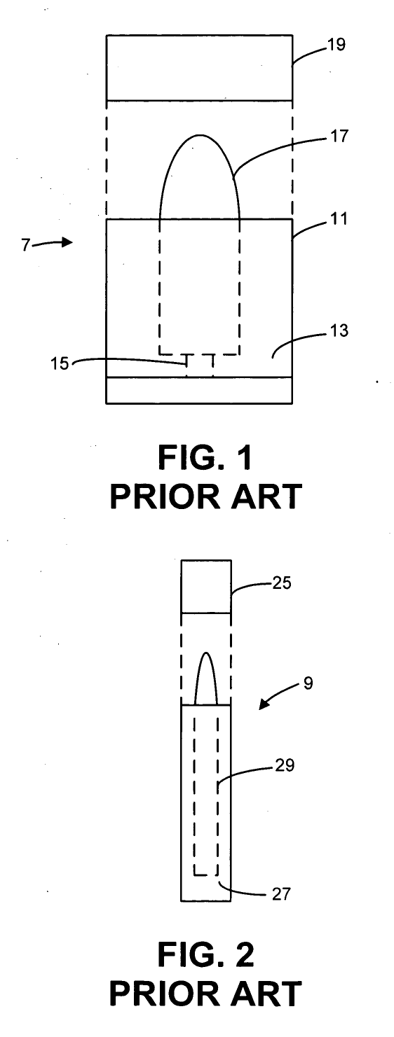

Embodiments consistent with the present invention include a holder, described below, to releasably hold conventional cosmetic tools. As one example, if this type of conventional cosmetic tool is a lipstick tool 7, as illustrated in FIG. 1, then it typically has the following components: a plastic casing (container) 11 holding the lipstick product 17 (composition to be applied to one's lips) and capable of releasably fitting within one of the ends of the holder, the casing 11 having an open end for extraction of the lipstick 17 and a solid end opposite the open end; a plastic cap 19 that fits on the open end of the casing 11; and a mechanism to extract the lipstick 17 such as a screw-type mechanism 15 in the casing 11 that causes extraction and retraction of the lipstick 17 when a particular portion 13 of the casing is twisted. When used up, the entire conventional cosmetic tool 7, including all of those components, is typically discarded, as this conventional cosmetic tool is not designed for replacement of only the cosmetic product (lipstick 17) within the tool.

As another example, if this type of conventional cosmetic tool is a lip liner tool 9, as illustrated in FIG. 2, then it typically has the following components: a casing (container) 27 holding the lip liner product 13 (composition to be applied to one's lips) and capable of releasably fitting within one of the ends of the holder, the casing 11 having the ability to have portions of it removed to expose the lip liner 29; and a cap 25 that fits over the exposed portion of the lip liner 29. As with cosmetic tool 7, when used up, the entire conventional cosmetic tool 9, including all of those components, is typically discarded, as this conventional cosmetic tool is not designed for replacement of only the cosmetic product (lip liner 29) within the tool.

Examples of additional types of conventional cosmetic tools designed for use as separate units not requiring a holder are shown in the product sheets from web sites submitted in Applicant's Information Disclosure Statement (“Statement”) filed on same date herewith, and all of those references (product sheets) are incorporated herein by reference. Cosmetic tools 7, 9, 22 and 24 (referenced below), as well as the other elements identified as cosmetic tools in the drawings for the present specification, are intended to generically represent conventional cosmetic tools, such as those shown in FIGS. 1 and 2, and those identified in the Statement, as they can have many different shapes and sized, as illustrated by the cosmetic tools in the Statement. Therefore, the disclosed and claimed conventional cosmetic tools refer not simply to only a cosmetic product or material, such as a stick of lipstick, but rather a whole conventional cosmetic tool designed for use as a separate unit, such as those having the components identified above and disclosed in the Statement. Given the various shapes and sizes of conventional cosmetic tools, such as those identified in the Statement, manufacturers of them can each configure and dimension the size of the holders to fit their respective conventional cosmetic tools.

### Holder

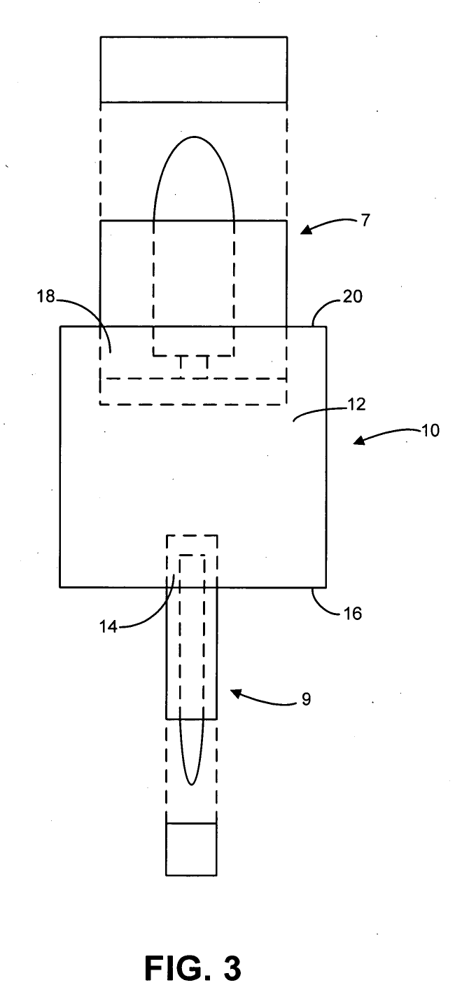

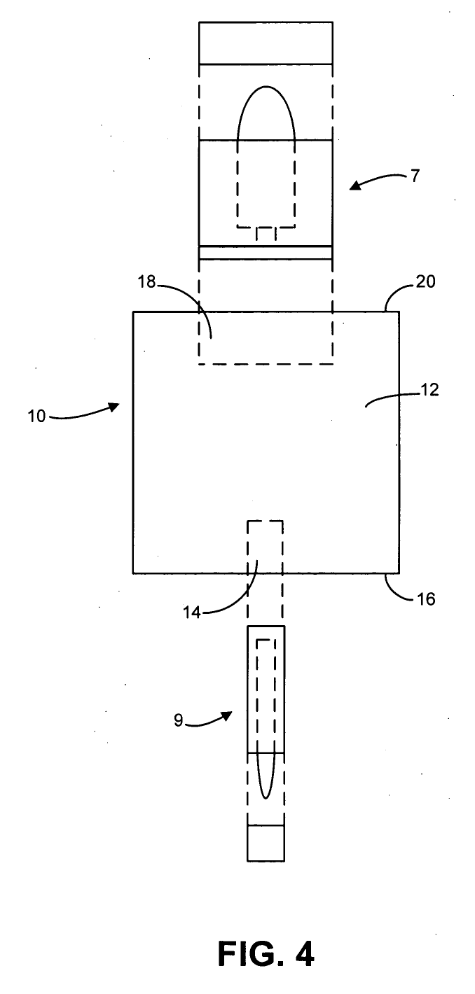

A holder consistent with the present invention can provide for a convenient way to hold multiple cosmetic tools for keeping them together and for use in applying the cosmetic products within them. FIG. 3 is a side view of a holder 10 to illustrate how the conventional cosmetic tools 7 and 9 are installed within the holder 10 for use in one embodiment. FIG. 4 is a side view of holder 10 to illustrate how the conventional cosmetic tools 7 and 9 can be released from the holder in one embodiment. As shown in FIGS. 3 and 4, holder 10 has a main body 12, an end 16 having an aperture 14 for releasably holding cosmetic tool 9, and an end 20 having an aperture 18 for releasably holding cosmetic tool 7. As shown in FIG. 3, cosmetic tools 7 and 9 are securely held within the ends of holder 10, permitting application of their cosmetic products (lipstick and lip liner). As shown in FIG. 4, cosmetic tools 7 and 9 can be released from the ends of holder 10, when used up for example, and replaced with new or different cosmetic tools. Examples of various ways for the cosmetic tools to be releasably held or installed in the holder are provided below.

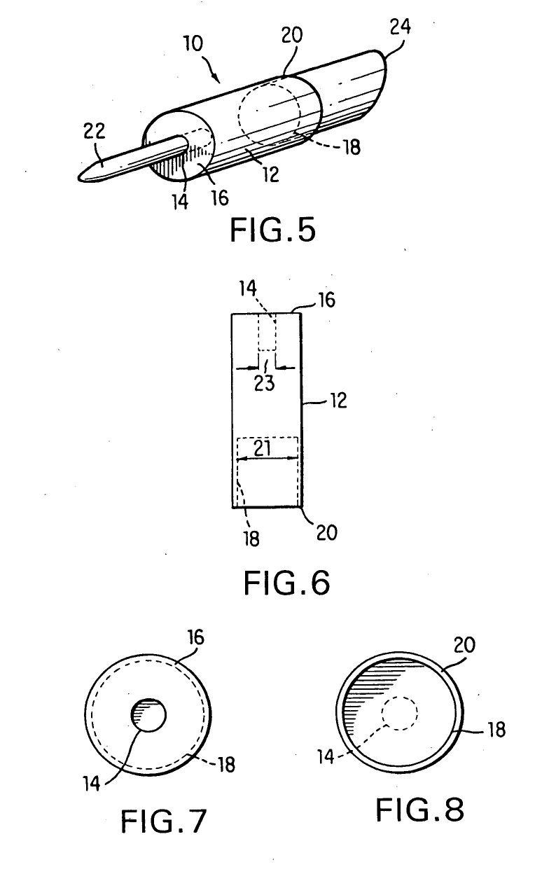

FIG. 5 is a perspective view of an embodiment of the holder 10 for releasably holding generic cosmetic tools 22 and 24, which can include the cosmetic tools 7 and 9, or possibly other types of cosmetic tools. FIG. 6 is a side view of holder 10, and FIGS. 7 and 8 are views of opposite ends of holder 10. Examples of cosmetic tools include, but are not limited to, the following: lipstick; lip brush; lip liner; eye liner; eye shadow; and those identified in the Statement. The term “cosmetic tool” includes any type of cosmetic product (composition to be applied to one's body) in any type of container that is designed for use as a separate unit not requiring the holder and thus can be independently used on a separate basis from the holder.

As shown in FIGS. 5-8, holder 10 includes a main body 12, which has two ends 16 and 20. Each end 16 and 20 has a holder for holding a cosmetic tool, and the holder can be implemented in many ways, examples of which are described below. The term “holder” includes any structure for holding a cosmetic tool. End 16 has an aperture 14 for releasably holding cosmetic tool 22, and end 20 has an aperture 18 for releasably holding cosmetic tool 24. As shown, cosmetic tools 22 and 24 are held in place substantially parallel to a central longitudinal axis of main body 12, although they could be held at an angle to main body 12.

FIG. 6 is a side view of the holder shown in FIG. 5 illustrating how cosmetic tools 22 and 24 can be releasably held in this exemplary embodiment. Aperture 14 in end 16 has a diameter 23 slightly less than a cross-sectional diameter of cosmetic tool 22, providing for a friction fit of the cosmetic tool, and aperture 18 in end 20 has a diameter 21 slightly less than a cross-sectional diameter of cosmetic tool 24, providing for a friction fit of the cosmetic tools into the respective ends of the holder. Apertures 14 and 18 also have a sufficient depth such that friction between the apertures and the ends of the cosmetic tools holds them securely in place and also permits them to be released from the ends and replaced with, for example, new cosmetic tools.

Accordingly, in embodiments of the present invention, at least one of the first cosmetic tool 22 or the second cosmetic tool 24 is a conventional cosmetic tool designed for use as a separate unit not requiring the first holder (on end 16, for example) or the second holder (on end 20, for example), respectively, of the holder (holder 10, for example). As also indicated above, these conventional cosmetic tools (7, 9, 22, and 24) can be independently used on a separate basis from holder 10 and thus do not require holder 10 to be used.

In view of the embodiments shown in FIGS. 3-8, implementations of the present invention can include three embodiments, for example. In a first exemplary embodiment, the present invention is a holder including: a main body having a first end and a second end; the first end having a first holder for holding a first cosmetic tool; and the second end having a second holder for holding a second cosmetic tool, wherein at least one of the first holder or the second holder provides for releasably holding the first cosmetic tool or the second cosmetic tool, respectively, and wherein at least one of the first cosmetic tool or the second cosmetic tool is a conventional cosmetic tool designed for use as a separate unit not requiring the first holder or the second holder, respectively.

In a second exemplary embodiment, the present invention is a holder including: a main body having a first end, a second end, and a central axis; the first end having a first holder for releasably holding a first cosmetic tool substantially parallel to the central axis and extending from the first end; and the second end having a second holder for releasably holding a second cosmetic tool substantially parallel to the central axis and extending from the second end, wherein at least one of the first cosmetic tool or the second cosmetic tool is a conventional cosmetic tool designed for use as a separate unit not requiring the first holder or the second holder, respectively.

In a third exemplary embodiment, the present invention is a method of applying cosmetic products using a holder and conventional cosmetic tools, including the steps of applying a first cosmetic product from a first cosmetic tool releasably held on a first end of a holder; and applying a second cosmetic product from a second cosmetic tool releasably held on a second end of the holder, wherein at least one of the applying steps includes applying the first or the second cosmetic product using the holder and wherein at least one of the first cosmetic tool or the second cosmetic tool is a conventional cosmetic tool designed for use as a separate unit not requiring the first holder or the second holder, respectively.

### Holder with a Friction Fit, Threaded Fit, and Optional Caps

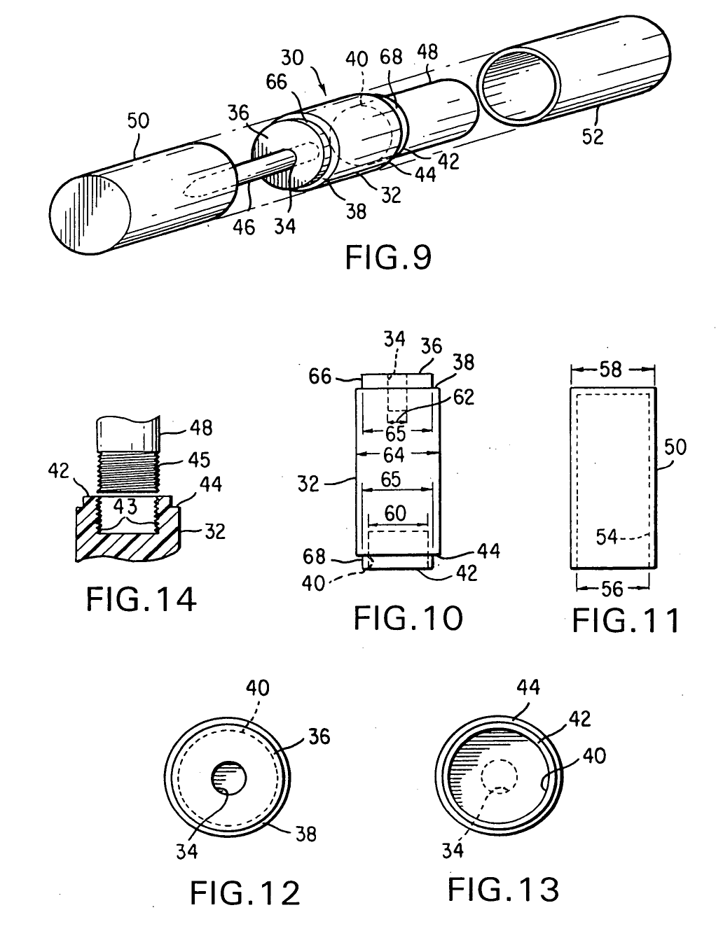

FIG. 9 is a perspective view of an embodiment of a holder 30 for releasably holding cosmetic tools 46 and 48, and optionally including caps 50 and 52. FIG. 10 is a side view of holder 30, and FIG. 11 is side view of cap 50. FIGS. 12 and 13 are opposite end views of holder 30. Caps 50 and 52 are not necessarily required since the cosmetic tools themselves typically already have caps. However, they can provide certain advantages or may be desired for any reason. Caps can be used, for example, to help protect the cosmetic tools so that they are not jarred loose from the main body such as when stored within a purse and so that any individual caps on the cosmetic tools are not necessarily needed. Also, the caps can have an exterior reflective surface to function as a mirror and assist a user in applying cosmetic tools held within holder 30 or for other purposes.

As shown in FIGS. 9-13, holder 30 includes a main body 32, which has two ends 36 and 42. Each end includes a holder as explained below. End 36 has an aperture 34 for releasably holding cosmetic tool 46, and end 42 has an aperture 40 for releasably holding cosmetic tool 48. As shown, cosmetic tools 46 and 48 are held in place substantially parallel to a central longitudinal axis of main body 32, although they could be held at an angle to main body 32.

Holder 30 in this exemplary embodiment also includes an alternative end structure. In particular, end 36 includes an edge 38 and a raised portion 66, and end 42 includes an edge 44 and a raised portion 68. The raised portion 66 and 68 provide for releasably securing caps 50 and 52 to main body 32. As shown in FIGS. 9 and 11, cap 50 has an interior portion 54 having a diameter 56 slightly less than diameter 65 of end 36, providing for a friction fit between interior portion 54 and raised portion 66. Cap 52 can have a similar construction so that it can be releasably held on end 42 through a friction fit with raised portion 68. Also, as shown in FIGS. 9 and 11 for this example, cap 50 has an outside diameter 58 substantially equal to diameter 64 of main body 32, and cap 52 likewise can have a similar construction and outside diameter dimension.

FIG. 10 also illustrates how cosmetic tools 46 and 48 can be releasably held in this exemplary embodiment. Aperture 34 in end 36 has a diameter 62 slightly less than a cross-sectional diameter of cosmetic tool 46, providing for a friction fit of the cosmetic tool, and aperture 40 in end 42 has a diameter 60 slightly less than a cross-sectional diameter of cosmetic tool 48, providing for a friction fit of the cosmetic tools into the respective ends of the holder. Apertures 34 and 40 also have a sufficient depth such that friction between the apertures and ends of the cosmetic tools holds them securely in place and also permits them to be released from the ends and replaced with, for example, new cosmetic tools.

FIG. 14 is a side view of a portion of holder 30 illustrating an optional holder for releasably containing a cosmetic tool. End 42 can alternatively include threading 43, and cosmetic tool 48 can be configured to include matching threading 45 on its exterior. Therefore, cosmetic tool 48 can be screwed onto end 42 and held securely in place. For replacement, cosmetic tool 48 can be unscrewed and a new one also having threading 45 can be installed.

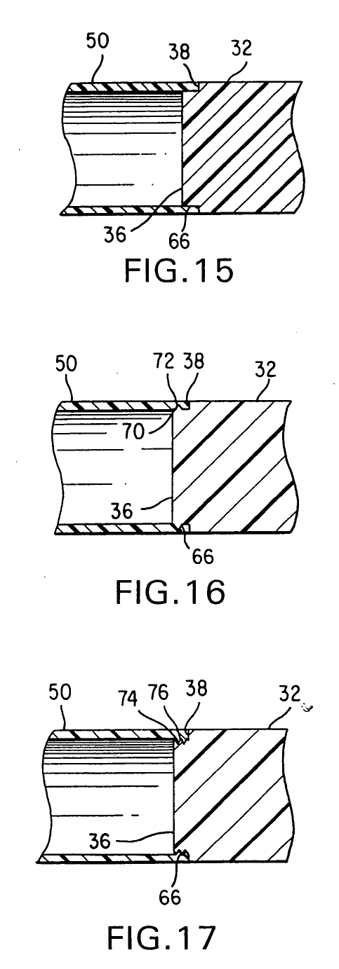

FIGS. 15-17 are side sectional views of an end of main body 32 illustrating the friction fit of cap 50 for installation and alternative ways to releasably install cap 50 or other caps. For example, FIG. 16 illustrates an alternative snap fit, in which cap 50 includes a groove 72 and raised portion 66 includes a ridge 70. Groove 72 snaps into ridge 70 to hold cap 50 in place. Cap 50 is preferably made of a material flexible enough to permit to be “snapped” into place over ridge 70 and subsequently removed. FIG. 17 illustrates an alternative threaded fit, in which cap 50 includes threading 76 and raised portion 66 includes matching threading 74. Cap 50 can thus screw onto end 36 for installation and be unscrewed to remove it. Cap 52 can also include these alternative structures for releasably holding it on end 42. In addition, each end 36 and 42 can have the same structure to install the respective cap, or they can have different structures.

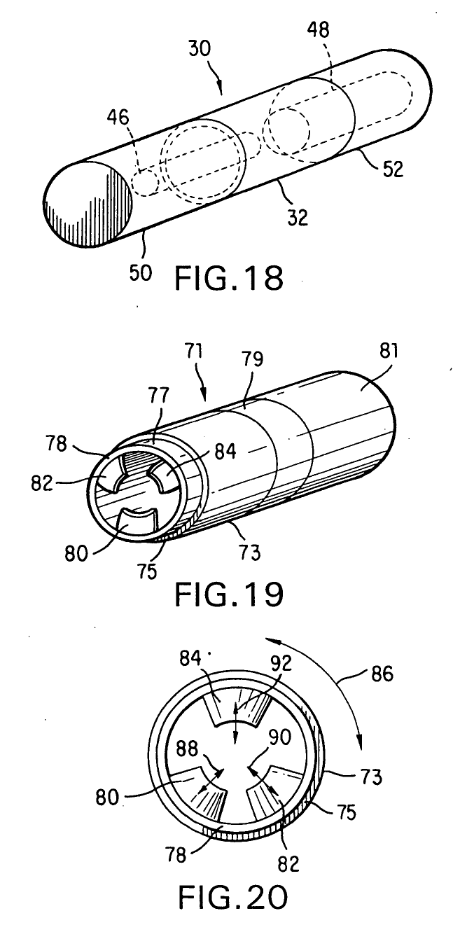

FIG. 18 is a perspective view of the holder 30 shown with caps 50 and 52 installed, regardless as to the type of structure used to secure the caps. As shown, caps 50 and 52 can provide for an aesthetically pleasing holder by covering the cosmetic tools 46 and 48 when not in use.

### Holder with a Chuck Mechanism

FIG. 19 is a perspective view of an embodiment of a holder 71 for releasably holding cosmetic tools and including a chuck mechanism 73 for holding variable size cosmetic tools. FIG. 20 is an end view of holder 71. As shown in FIG. 19, holder 71 includes chuck mechanism 73 on one end and can include another chuck mechanism 81 on the other end. A main body 79 joins and provides structural support for chuck mechanisms 73 and 81. Chuck mechanism 73 includes an end 78 having an edge 75 joined with a raised portion 77, similar to that shown for holder 30 described above. End 78 includes jaws 80, 82, and 84 for releasably holding cosmetic tools of variable dimensions such as cosmetic tools having different cross-sectional diameters as illustrated above with respect to cosmetic tools 22, 24, 46, and 48. Each chuck mechanism 73 and 81 can also have a cap such as those caps described above.

FIG. 20 illustrates operation of chuck mechanism 73. Rotational movement of chuck mechanism 73, as represented by arrows 86, causes lateral movement of jaws 80, 82, and 84, as represented by arrows 88, 90, and 92. A cosmetic tool, when installed, is held securely in place by jaws 80, 82, and 84. The cosmetic tool can be released by rotational movement of chuck mechanism 73 causing jaws 80, 82, and 84 to open. In addition to lateral movement, the jaws may also move in longitudinal direction as known in the art for conventional chuck mechanisms. Chuck mechanism 81 can operate in a similar fashion. Chuck mechanisms are known in the art and examples are described in the following patents, which are incorporated herein by reference: U.S. Pat. Nos. 6,129,363; and 6,105,974. The term “chuck mechanism” includes any mechanism having movable jaws for releasably holding variable size items.

### Holder with a Compressible Material

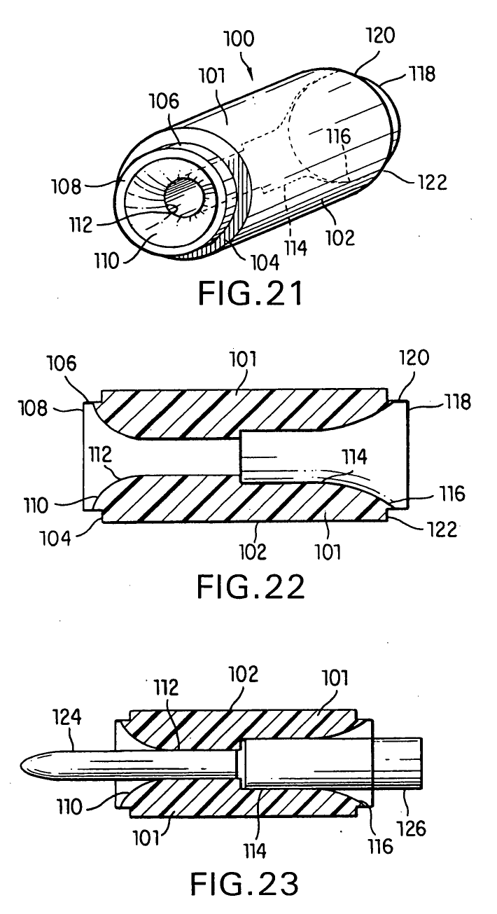

FIG. 21 is a perspective view of an embodiment of a holder 100 for releasably holding cosmetic tools and including a compressible material 101 for holding variable size cosmetic tools. FIG. 22 is a side sectional view of holder 100, and FIG. 23 is a side sectional view of holder 100 with cosmetic tools 124 and 126 releasably installed. As shown in FIGS. 21 and 22, holder 100 includes an end 108 having an edge 104 and a raised portion 106, and an end 118 having an edge 122 and a raised portion 120, similar to the ends for holder 30 described above. Ends 108 and 118 can also have caps such as described above. A main body 102 contains compressible material 101, which has an aperture 112 at end 108 and an aperture 114 at end 118. Aperture 112 includes a curved portion 110 and aperture 114 includes a curved portion 116. The curved portions can permit easier installation of cosmetic tools.

As shown in FIG. 23, cosmetic tool 124 can be installed in aperture 112 and cosmetic tool 126 can be installed in aperture 114. Compressible material 101 preferably has a sufficient compressibility to permit installation of variable dimensioned cosmetic tools while also having sufficient rigidity to securely hold the cosmetic tools in place. It can be implemented with, for example, a foam rubber material.

As shown, compressible material 101 can include apertures 112 and 114 of different diameters to permit installation of cosmetic tools within a different range of diameters or dimensions. For example, aperture 112 can permit installation of various lip liner products having variable dimensions, and aperture 114 can permit installation of various lipstick products having variable dimensions. Since lip liner products in general have small dimensions than lipstick products, aperture 112 is small than aperture 114, Alternatively, compressible material 101 can have one uniform diameter aperture.

### Configurations for the Holders

The holders 10, 30, 71, and 100 described above, or others consistent with the present invention, can have a variety of configurations. The entire holder is preferably long enough to comfortably grasp but not so long as to be cumbersome or difficult to fit within a conventional purse or other container. It can, however, be made any desired length. The holders can include a variety of types of holders on the ends, such as those examples described above, including holders for variable size cosmetic tools. Furthermore, each end can include the same type of holder or a different type. When in place, the cosmetic tools are preferable held securely enough to permit application of them. Releasable holders provide the advantage of, for example, permitting use of the holder with conventional cosmetic tools and permitting those products to be replaced in the holder when used up. Alternatively, instead of being releasably held in the holders, one of the cosmetic tools can be permanently attached to the main body.

The main body and the optional caps can have a variety of cross-sectional shapes, and it is shown as round for illustrative purposes only. Those shapes can include a combination of curved surfaces (for example, round or oval); a combination of planar surfaces (for example, square, rectangular, hexagonal, or octagonal); or a combination of planar and curved surfaces (for example a square-type shape having two opposite flat surfaces and two opposite curved surfaces).

The curved surfaces for any of the shapes can include concave surfaces, convex surfaces, or a combination. Also, the main body and caps can each have the same or a different configuration that includes a combination of the cross-sectional shapes identified above. For the caps, the interior surface can have a different cross-sectional shape than the exterior surface; for example, they may have a square exterior shape and a round interior shape.

The main body and caps can be made of a variety of materials such as, for example, plastic or metal. The surface of the material can be reflective to use the main body or caps as a mirror, and those reflective surfaces can include, for example, a shiny plastic or a polished metal.

The exterior surface of the main body and caps can have any color, combinations of colors, or patterns. It may include logos, monograms, text, or other markings. For example, the holder may include advertising or be personalized to identify the owner of it. As another example, manufacturers of cosmetic tools, such as those identified in the Statement, can each configure and dimension the size of the holders to fit their respective conventional cosmetic tools, and they can include text, designs, shapes, or coloring on the holder to identify their trademarks for the cosmetic tools or other information such as promotions.

The holder can be configured to hold different size cosmetic tools, such as those shown with holders 10, 30, and 100. For example, it can hold a lip liner and a lipstick. Alternatively, it can be configured to hold the same size cosmetic tools. For example, it can hold two lipsticks.

### Methods of Use

The following describes an example of a potential method of use of any of the holders described above for applying lipstick: remove the cap over the lip liner; if necessary, remove lip liner cap; apply lip liner using the cap as a mirror; replace cap(s) over the lip liner; remove cap over the lipstick; if necessary, remove lipstick cap; if necessary, raise the lipstick product by firmly grasping the main body of the holder and twisting the lipstick product, or by firmly grasping the lipstick product and twisting the main body; apply the lipstick using the cap as a mirror; and replace cap(s) over the lipstick.

The following describes an example of another potential method of use for any of the holders described above for applying the eye liner and eye shadow: remove the cap over the eye liner; if necessary, remove eye liner cap; apply eye liner using the cap as a mirror; replace cap(s) over the eye liner; remove cap over the eye shadow; if necessary, remove eye shadow cap; apply the eye shadow using the cap as a mirror; and replace cap(s) over the eye shadow.

Still other methods can involve use of other types of cosmetic tools such as those identified above. In addition, if the caps are not used, then the holder caps need not be removed and replaced in the methods.

While the present invention has been described in connection with an exemplary embodiment, it will be understood that many modifications will be readily apparent to those skilled in the art, and this application is intended to cover any adaptations or variations thereof. For example, various shapes, configurations, and materials for the holder may be used without departing from the scope of the invention. This invention should be limited only by the claims and equivalents thereof.

1. A holder, comprising:
a main body having a first end and a second end;
the first end having a first holder for holding a first cosmetic tool; and
the second end having a second holder for holding a second cosmetic tool,
wherein at least one of the first holder or the second holder provides for releasably holding the first cosmetic tool or the second cosmetic tool, respectively, and wherein at least one of the first cosmetic tool or the second cosmetic tool is a conventional cosmetic tool designed for use as a separate unit not requiring the first holder or the second holder, respectively.

2. The holder of claim 1 wherein:
the first holder provides for a friction fit between the first end and the first cosmetic tool; and
the second holder provides for a friction fit between the second end and the second cosmetic tool.

3. The holder of claim 1 wherein the first holder and the second holder are each configured to hold one or more of the following: a lipstick tool; a lip liner tool; an eye liner tool; or an eye shadow tool.

4. The holder of claim 1, further including:
a removable first cap enclosing the first cosmetic tool on the first end; and
a removable second cap enclosing the second cosmetic tool on the second end.

5. The holder of claim 4 wherein the first end and the second end each include one of the following for releasably holding the first cap and the second cap: a friction fit; a snap fit; or a threaded fit.

6. The holder of claim 4 wherein at least one of the first cap or the second cap includes a reflective outer surface.

7. The holder of claim 4 wherein the first cap and the second cap are each composed of one of the following materials: a metal; or a plastic.

8. The holder of claim 4 wherein at least a portion of the first cap and at least a portion of the second cap each has one of the following cross-sectional shapes: a combination of planar surfaces; a combination of curved surfaces; or a combination of curved and planar surfaces.

9. The holder of claim 1 wherein at least a portion of the main body has one of the following cross-sectional shapes: a combination of planar surfaces; a combination of curved surfaces; or a combination of curved and planar surfaces.

10. The holder of claim 4 wherein the main body, the first cap, and the second cap have substantially the same cross-sectional shape.

11. The holder of claim 4 wherein at least one of the first cap or the second cap has exterior and interior surfaces, the exterior surface having a different cross-sectional shape than the interior surface.

12. The holder of claim 1 wherein at least one of the first or second holders includes an aperture for providing a friction fit with a cosmetic tool.

13. The holder of claim 1 wherein at least one of the first or second holders includes a threaded aperture for releasably holding a cosmetic tool having matching threading.

14. The holder of claim 1 wherein at least one of the first or second ends includes a chuck mechanism for releasably holding cosmetic tools having variable size dimensions.

15. The holder of claim 1 wherein at least one of the first or second ends includes a compressible material, having an aperture, for releasably holding cosmetic tools having variable size dimensions.

16. A holder, comprising:
a main body having a first end, a second end, and a central axis;
the first end having a first holder for releasably holding a first cosmetic tool substantially parallel to the central axis and extending from the first end; and
the second end having a second holder for releasably holding a second cosmetic tool substantially parallel to the central axis and extending from the second end, wherein at least one of the first cosmetic tool or the second cosmetic tool is a conventional cosmetic tool designed for use as a separate unit not requiring the first holder or the second holder, respectively.

17. The holder of claim 16, further including:
a first cap removably held on the first end; and
a second cap removably held on the second end.

18. The holder of claim 16 wherein at least one of the first or second ends is configured to releasably hold cosmetic tools having variable dimensions.

19. The holder of claim 16 wherein the first and second holders are configured to hold cosmetic tools of different dimensions.

20. A method of applying cosmetic products using a holder and conventional cosmetic tools, comprising:
applying a first cosmetic product from a first cosmetic tool releasably held on a first end of a holder; and
applying a second cosmetic product from a second cosmetic tool releasably held on a second end of the holder,
wherein at least one of the applying steps includes applying the first or the second cosmetic product using the holder and wherein at least one of the first cosmetic tool or the second cosmetic tool is a conventional cosmetic tool designed for use as a separate unit not requiring the first holder or the second holder, respectively.
